(19) United States
(12) Patent Application Publication
(10) Pub. No.: US 2026/0045774 A1
(43) Pub. Date: Feb. 12, 2026

(54) ISLANDING SWITCH INCLUDING A COUPLING ASSEMBLY FOR INTEGRATION WITH A METER CIRCUIT INTERRUPTER

(71) Applicant: EATON INTELLIGENT POWER LIMITED, DUBLIN (IE)

(72) Inventors: Suhas Vishwanath Dhakate, Pune (IN); Himadri Dipakjyoti Sengupta, Pune (IN); Mahesh Ighe, Pune (IN)

(73) Assignee: EATON INTELLIGENT POWER LIMITED, DUBLIN (IE)

(21) Appl. No.: 18/795,462

(22) Filed: Aug. 6, 2024

(51) Int. Cl. H02B 1/04; H02J 3/38

(52) U.S. Cl. CPC H02B 1/04; H02J 3/388

(57) ABSTRACT

An islanding switch for use in a load panel includes a frame including islanding circuits, and a coupling assembly. The frame also includes a top having multiple openings, a sidewall extending downward from the top, multiple channels extending vertically between the peripheries of the openings to bottom edge of the sidewall, and multiple socket joints extending horizontally across the channels above the bottom edge. The coupling assembly includes a base, multiple coupling busbars including inner portions embedded within the base and outer portions structured to be affixed to the meter and the branch circuit breakers, multiple sockets having lower ends affixed to inner portions of respective coupling busbars and upper ends affixed to respective socket joints. The islanding circuits include switching elements and a control circuit structured to cause the switching elements to disconnect the DERs from the utility grid upon detecting a power outage.

### FIELD OF THE INVENTION

The disclosed concept relates generally to an anti-islanding device, and in particular, to an islanding switch including a coupling arrangement for integration with a meter breaker in a load center.

### BACKGROUND OF THE INVENTION

Solar energy, or photovoltaic (PV) systems coupled with energy storage systems have increasingly become an alternative to diesel generators for back-up power for single-family residences, multi-family residences, or small commercial or industrial businesses. As electric vehicles (EVs) increase in popularity, EV chargers will become commonplace at these locations with the opportunity to leverage the EV as backup power as well. These PV inverters, EV chargers, and energy storage battery inverters (collectively referred to as distributed energy resources (DERs)) are each connected to an electrical main panel, which interfaces with the utility grid (hereinafter, also referred to as the grid) and draws power from this connection to power normal loads and to charge vehicles or batteries. For example, during an intentional islanded mode in which the grid is disconnected, the DERs may provide energy to at least critical loads (e.g., HVAC system, furnace, fans, etc.). During the grid-connected mode, the DERs may supply to the grid any excessive power generated by them.

During an unintentional islanding (e.g., a power outage), however, the DERs must be disconnected from the grid since continuous power supply from the DERs to the grid can pose serious safety risks. For example, the utility personnel performing repairs to the grid may encounter live circuits, and thus sustain electric shocks or injuries. Further, the grid itself or its equipment may suffer damage or malfunction due to mismatched voltage and frequency between the DERs and the grid. In order to avoid such damages and hazards, the standards (e.g., UL1741 or IEEE1547) require an anti-islanding device for inverters and power converter equipment used in the DERs to prevent the DERs from continuing to supply power to the grid during the power outages. An anti-islanding device is an islanding switch (e.g., without limitation, a microgrid interconnect device) including a switching element such as a relay or switch, a control circuit, a communication circuit and a measurement circuit. An islanding switch is typically connected at the point of common coupling, which serves as a boundary between the DERs and the grid. Upon detection of a power loss, the islanding switch is turned OFF, and thus disconnects the DERs from the grid. Upon detection of the presence of grid power, the islanding switch reconnects the DERs to the grid and allows the DERs to supply power to the grid. However, the conventional islanding switches are very large, and thus need to be installed separately from the existing load panels as illustrated in FIG. 7.

FIG. 7 illustrates an energy distribution system 2 implementing a conventional islanding switch 150 (disposed within an islanding unit 152). As shown in FIG. 7, the islanding switch 150 is installed between the existing load panel 20 and an additional load panel 30. The existing load panel 20 includes a meter breaker 300 and branch circuit breakers 400. However, in order to connect the islanding switch 150 to the grid 3, the meter breaker 300 is disconnected from the branch circuit breakers 400 and rewired 40 to be connected to the islanding switch 150 (i.e., inputs of the switching element 151). It is noted that FIG. 7 does not show other components (e.g., without limitation, a control circuit, etc.) of the islanding switch 150 for brevity and clarity of illustration. Further, the additional load panel 30 is needed to house new branch circuit breakers 402 which are to be connected to the islanding switch 150 and the loads 7 since the existing branch circuit breakers 400 are disconnected from the meter breaker 300 and the loads 7. Thus, in order to implement the conventional islanding switch 150 in the energy distribution system 2, not only is it necessary to install a new load panel 30 and new branch circuit breakers 402, but also extensive rewiring 40 is required as shown in FIG. 7. Such additional installations and extensive rewiring are costly and demand substantial time, resources and space that are already limited. Additionally, the conventional islanding switch 150 may also require the removal of the existing backpan and addition of a new backpan assembly (not shown) for a proper mounting of the islanding switch 150, adding further installation costs. In some cases, if an islanding switch has sufficient room to include the meter breaker, the meter breaker can be relocated therein and connected to the switching elements of the islanding switch. However, this alternative arrangement still requires installation of a new load center and new branch circuit breakers as well as extensive rewiring that are likewise costly and time consuming.

There is room for improvement in the energy distribution systems, in particular the islanding switches.

### SUMMARY OF THE INVENTION

These needs, and others, are met by an islanding switch for use in a load panel included in an energy distribution system comprising one or more distributed energy resources (DERs), a utility grid and loads, the load panel including a meter breaker connected to the utility grid and branch circuit breakers connected to the loads, the islanding switch comprising: a frame including a top having multiple openings, a sidewall extending vertically downward from the top, multiple channels extending vertically between the peripheries of the openings to bottom edge of the sidewall, and multiple socket joints extending horizontally across the channels above the bottom edge; islanding circuits disposed within the frame and including switching elements, a measurement circuit structured to measure line voltage, and a control circuit structured to detect a loss or presence of grid power based on the measured line voltage and cause the switching elements to disconnect the DERs from the utility grid upon detecting the power loss and connect the DERs to the utility grid upon detecting the presence of grid power; and a coupling assembly including a base attached to the bottom edge of the sidewall, multiple coupling busbars including inner portions embedded within the base and outer portions structured to be affixed to the meter breaker and the branch circuit breakers, multiple sockets having lower ends affixed to inner portions of respective coupling busbars and upper ends affixed to respective socket joints.

Another example embodiment provides a load panel for use in an energy distribution system including comprising one or more distributed energy resources (DERs), a utility grid and loads, the load panel comprising: a housing; a meter breaker disposed within the housing and including line conductors connected to the utility; a plurality of branch circuit breakers disposed within the housing and connected to the loads; and an islanding switch including a coupling assembly connecting the meter breaker and the branch circuit breakers, wherein the islanding switch is structured to disconnect the DERs from the utility grid and prevent the DERs from supplying power to the utility grid during a power outage and connect the DERs to the utility grid and allow the DERs to supply power to the utility grid during a grid-connected mode.

Yet another example embodiment provides an energy distribution system comprising: a plurality of loads; a utility grid structured to provide power to the loads during a grid-connected mode; one or more distributed energy resources (DERs) structured to supply power to the utility grid during the grid-connected mode and provide power to the loads during an islanded mode; and a load panel including a housing, a meter breaker disposed within the housing and including line conductors connected to the utility, a plurality of branch circuit breakers disposed within the housing and connected to the loads; and an islanding switch including a coupling assembly connecting the meter breaker and the branch circuit breakers, wherein the islanding switch is structured to disconnect the DERs from the utility grid and prevent the DERs from supplying power to the utility grid during a power outage and connect the DERs to the utility grid and allow the DERs to supply power to the utility grid during a grid-connected mode.

### BRIEF DESCRIPTION OF THE DRAWINGS

A full understanding of the invention can be gained from the following description of the preferred embodiments when read in conjunction with the accompanying drawings in which:

FIG. 1 illustrates an energy distribution system in accordance with a non-limiting example embodiment of the disclosed concept;

FIG. 2 illustrates a partial interior view of a load panel integrating an islanding switch in accordance with a non-limiting example embodiment of the disclosed concept;

FIG. 3 is a block diagram of the integrated islanding switch of FIG. 2 in accordance with a non-limiting example embodiment of the disclosed concept;

FIG. 4 is a perspective view of an exemplary coupling assembly for integrating an exemplary islanding switch in the load panel of FIG. 2 in accordance with a non-limiting example embodiment of the disclosed concept,

FIG. 5 illustrates the integration process of the exemplary islanding switch to the load panel using the exemplary coupling assembly of FIG. 4 in accordance with a non-limiting example embodiment of the disclosed concept;

FIG. 6 illustrates the integration process of FIG. 5 in further detail in accordance with a non-limiting example embodiment of the disclosed concept;

FIG. 7 is a block diagram of an energy distribution system implementing a conventional islanding switch; and

FIG. 8 is a perspective view of attaching the exemplary islanding switch to another exemplary coupling assembly in accordance with a non-limiting example embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

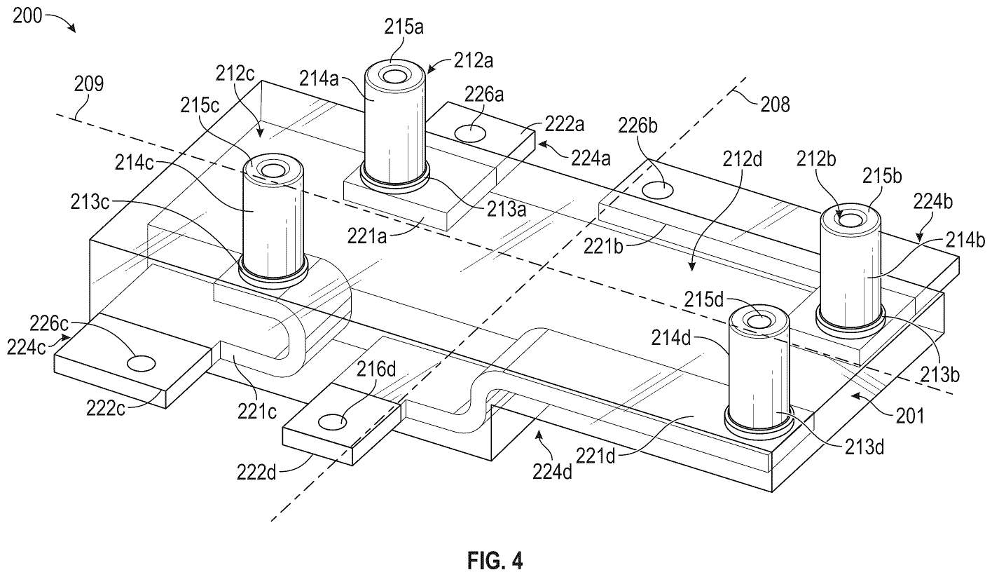

As employed herein, a “longitudinal axis” is generally parallel to the longest dimension of a device being described. When describing the device in a fully installed orientation.” A “lateral axis” extends normal to the longitudinal axis. A “transverse axis” extends normal to both the longitudinal and lateral axes. For example, sockets of the coupling assembly in FIG. 4 extend outward in parallel to the transverse axis.

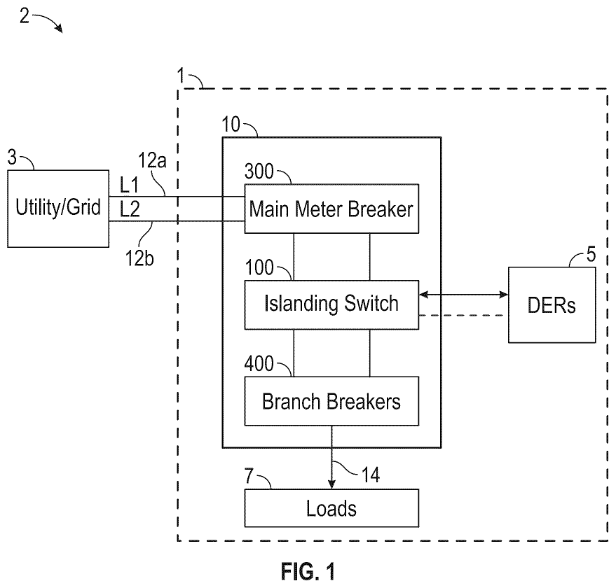

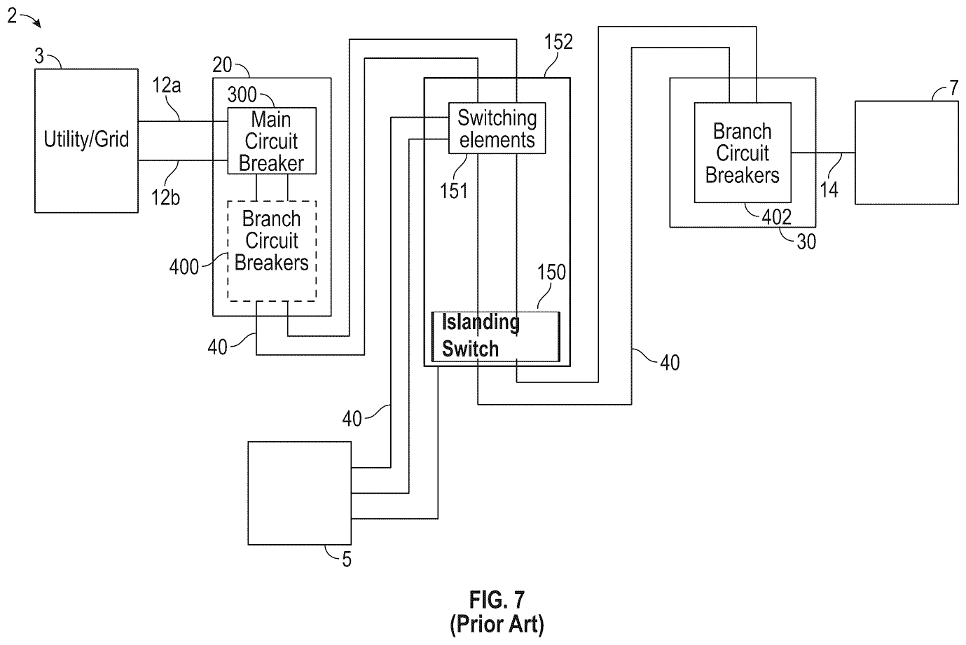

FIG. 1 is a block diagram of an energy distribution system 2 in accordance with a non-limiting, exemplary embodiment of the disclosed concept. The energy distribution system 2 includes a utility grid 3, distributed energy resources (DERs) 5, a load panel 10 connected to the DERs 5, and loads 7 connected to the load panel 10. While the energy distribution system 2 includes other entities such as an aggregator or the utility server, FIG. 1 does not show these entities for brevity of illustration. The DERs 5 include, e.g., without limitation, a battery equipped with an inverter, an electrical vehicle or a generator. The DERs 5, the load panel 10 and the loads 7 form a microgrid. The microgrid 1 can be connected to the utility gird 3 and operate in a grid-connected mode in which the grid 3 provides power to the loads 7. The microgrid 1 can be disconnected from the grid 3 and operate independently from the grid 3 in an islanded mode in which the DERs 5 supply power to the loads 7. During the grid-connected mode, the DERs 5 can supply power to the grid 3. However, when a power outage (unintentional islanding) occurs, the microgrid 1 (in particular, the DERs 5) must be disconnected from the grid 3 in order to prevent the DERs 5 from supplying power to the grid 3. As mentioned previously, an islanding switch as an anti-islanding measure is utilized to disconnect the DERs 5 from the grid 3 during the power outage. However, implementing a conventional islanding switch in an energy distribution system is not a simple feat. Due to its large size or safety implications, the conventional islanding switch needs to be installed separately and externally to an existing load panel, and thus cables and connections need to be rewired to connect the meter breaker to the islanding switch. In addition, a new load panel 30 including additional branch circuit breakers 402 needs to be installed and connected to the conventional islanding switch 150 as shown in FIG. 7.

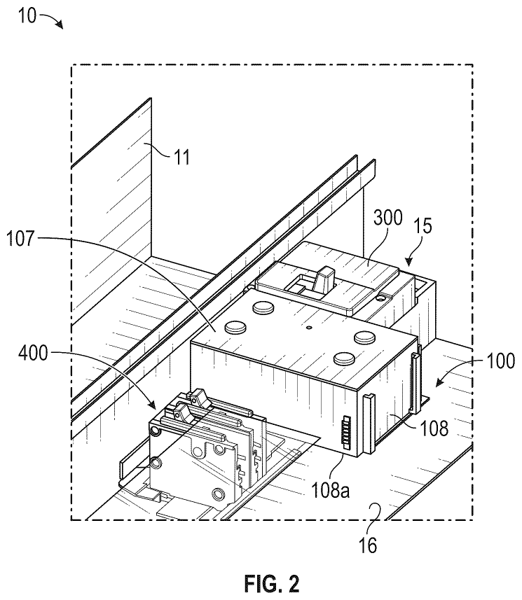

The exemplary embodiments of the disclosed concept, however, provide a novel compact islanding switch 100 and a novel coupling assembly 200 that allow implementing the required anti-islanding measures without having to install additional equipment and perform extensive rewiring. The islanding switch 100 is novel in that its size has been significantly reduced as compared to the conventional islanding switches 150 so as to fit between the meter breaker 300 and the branch circuit breakers 400 in the existing load panel 10 as shown in FIG. 2. Further, the islanding switch 100 includes all of the components of the conventional islanding switch 150, whose sizes have been also significantly reduced to fit within the compact islanding switch 100. Additionally, the novel coupling assembly 200, also compact in size, has been developed to integrate the compact islanding switch 100 within the existing load panel 10 with no or minimal modification. Thus, unlike the conventional islanding switches 150, the novel islanding switch 100 and coupling assembly 200 allow a simple retrofitting of the existing load panel 10 with the novel islanding switch 100. The retrofitted load panel 10, the islanding switch 100, the coupling assembly 200 and the integration of the islanding switch 100 within the load panel 10 using the coupling assembly 200 are discussed now in detail with reference to FIGS. 1-6.

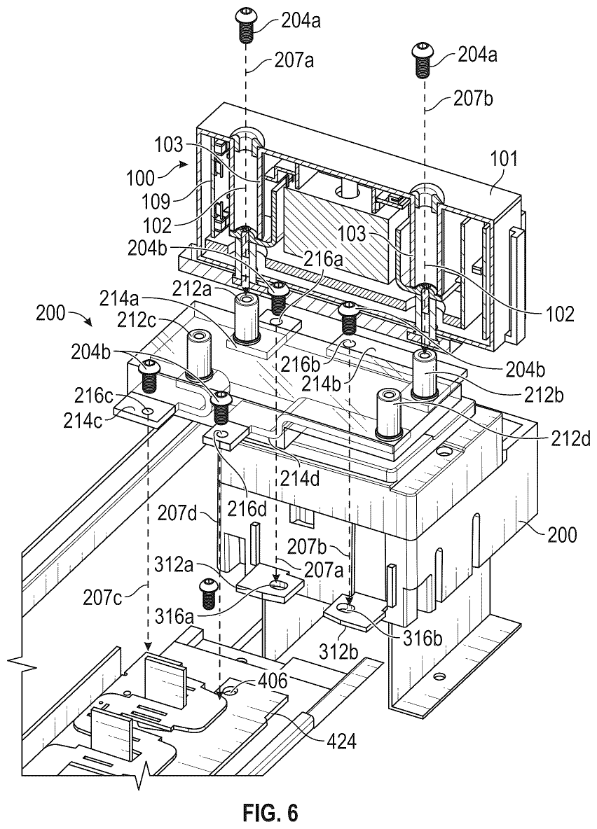

The load panel 10 may be any type of existing load center, a meter socket load center, a meter load center or service entrance equipment. The load panel 10 includes a housing 11 in a rectangular shape having a door (not shown), a backpan assembly (not shown), an enclosure 15, and a backwall 16. A backpan assembly includes a front panel structured to cover the components of the load panel 10 and the wirings therein, except for the levers of the circuit breakers so as to prevent exposing the components and wirings in the open. The enclosure 15 includes an islanding switch 100, a coupling assembly 200, a meter breaker 300 and branch circuit breakers 400 disposed on inner surface of the backwall 16. The meter breaker 300 is a standard meter breaker that combines a meter socket and a main circuit breaker as a unit. It may be, e.g., without limitation, a double pole meter breaker 300 and connected to the grid 3 via grid line conductors (L1 conductor 12a, L2 conductor 12b). The meter breaker 300 includes output terminals 312a,312b including thru-holes 316a,316b (as shown in FIG. 6). The output terminal 312a is connected to the L1 conductor 12a and the output terminal 312b is connected to the L2 conductor 12b. The meter breaker 300 is structured to provide power from the grid 3 to the branch circuit breakers 400 during the grid-connected mode and interrupt current from flowing to the loads 7 in an event of a severe fault, e.g., without limitation, an overload condition, a short circuit, etc. Further, upon detection of a power outage, the meter breaker 300 is structured to be turned OFF.

The branch circuit breakers 400 may be, e.g., without limitation, single pole smart circuit breakers connected to the DERs 5 and the loads 7. The branch circuit breakers 400 include line terminals (not shown) connected to a branch busbar 424 attached to the inner surface of the backwall 16. The branch busbar 424 includes two thru-holes 406 (only one thru-hole 406 is shown in FIG. 6 for the brevity and clarity of illustration). The branch busbar 424 in turn is connected to the input terminals of the branch circuit breakers 400. The branch circuit breakers 400 are structured to be connected to the DERs 5 and the meter breaker 300 via the islanding switch 100. The branch circuit breakers 400 are structured to supply power to the loads 7 from the utility grid 3 or the DERs 5 and interrupter current from flowing to the loads in an event of a fault (e.g., overcurrent event, short circuit events). The branch circuit breakers 400 supply power to the loads 7 from the grid 3 during the grid-connected mode and from the DERs 5 during the islanded mode. The branch circuit breakers 400 may be controlled by a user remotely.

The islanding switch 100 is connected to the meter breaker 300 and the branch circuit breakers 400 in series by the coupling assembly 200. It is also connected to the DERs 5. The islanding switch 100 is structured to be turned OFF to disconnect the DERs 5 from the grid 3 and prevent the DERs 5 from supplying power to the grid 3 during a power outage. The islanding switch 100 is further structured to be turned ON to (re) connect the DERs 5 to the grid 3 upon detection of presence of the grid power and allow the DERs 5 to supply power to the grid 3 during the grid-connected mode. The grid power is detected based on measurement of grid line voltage (also referred to herein as line voltage). The dimensions and directionalities of the islanding switch 100 and its components are described relative to the load panel 10 lying horizontally on its backwall 16 with the door facing upward.

The islanding switch 100 includes a frame 101 and a plurality of islanding circuits disposed within the frame 101. While FIGS. 2-6 show the frame 101 having a rectangular shape, this is for illustrative purposes only, and thus the housing can have any other appropriate shape to accommodate the configuration and spacing of the existing load panel 10 and/or the meter breaker 300 without departing from the scope of the disclosed concept. The frame 101 has a top 107 having a plurality openings 106a-d, sidewalls 108 extending downward from the top 107 and forming an opening at the bottom edge 108a, a plurality of channels 103 extending vertically between the peripheries of the openings 106a-d and the bottom edge 108 of the sidewall 108, and a plurality of socket joints 102 extending horizontally across the channels 103 above the bottom edge 108a. The socket joints 102 may be, e.g., without limitation, clinch nuts structured to be fastened to the coupling assembly 200 (specifically, the sockets 212a-d) so as to affix the islanding switch 100 to the coupling assembly 200. The frame 101 further includes a communication port 104 communicatively coupled to the DERs 5 and any other components of the energy distribution system 2 and structured to receive a signal(s) therefrom. The islanding switch 100 is structured to be turned ON or OFF to connect or disconnect the DERs 5 from the grid 3 or perform any other appropriate functions based on the signals.

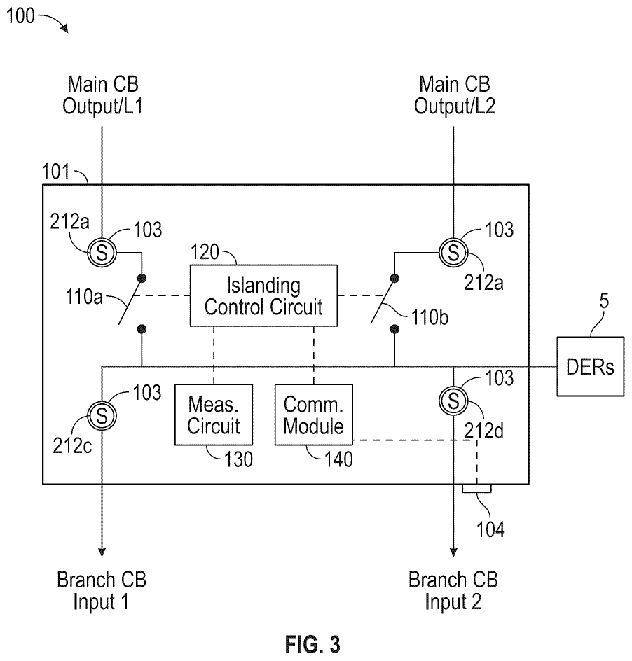

The plurality of islanding circuits may be disposed on a printed circuit board (e.g., without limitation, the printed circuit board 109 as shown in FIG. 6) disposed within the housing 101. The islanding circuits include switching elements 110a, 110b, a control circuit 120, a measurement circuit 130 and a communication module 140 as illustrated in FIG. 3. The switching elements 110a, 110b are connected to the DERs 5 and the grid 3. The switching elements 110a and 110b, for example, are connected to the line conductors 12a and 12b, respectively, via the output terminals 312a and 312b, of the meter breaker 300. The switching elements 110a and 110b are connected to the DERs 5 and the branch circuit breakers 400, which is in turn connected to the loads 7. Hence, the switching elements 110a, 110b are referred to as being connected to the grid 3 on the line side and the DERs 5 and the branch circuit breakers 400 on the load side. The switching elements 110a, 110b may include, e.g., without limitation, relays, analog mechanical switches, or semiconductor switching devices. The measurement circuit 130 may be, e.g., without limitation, a microcontroller structured to measure the line voltage or any change thereof and transmit a signal indicative of the measured line voltage to the control circuit 120. The communication module 140 is connected to the communication port 104 and structured to receive a signal(s) from any of the components within the energy distribution system, e.g., without limitation, the DERs 5, the loads 7, the utility 3, the aggregator, etc.

The control circuit 120 may be a processing unit, which may include a processor, a memory and/or other integrated circuits (e.g., without limitation, Modbus, LAN connection circuits). The processor may be, for example and without limitation, a microprocessor, a microcontroller, or some other suitable processing device or circuitry. The memory can be any of one or more of a variety of types of internal and/or external storage media such as, without limitation, RAM, ROM, EPROM(s), EEPROM(s), FLASH, and the like that stores, e.g., without limitation, programs, control logic, software and instructions for the processor to perform. The control circuit 120 is connected to the switching elements 110a, 110b, the measurement circuit 130 and the communication module 140 and is structured to control the islanding operation of the islanding switch 100. That is, the control circuit 120 is structured to detect a power outage based on a signal from the measurement circuit 130 and/or the communication module 140 and cause the switching elements 110a, 110b to be turned ON or OFF based on the signal. Further, the control circuit 120 is connected to the sockets 212a-d and transmits a control signal to the sockets 212a-d.

For example, the control circuit 120 can detect a loss of the grid power based on a signal from the measurement circuit 130 indicating that no line voltage has been measured for a predetermined period (e.g., without limitation, 60 seconds). Upon detection of the loss of the grid power, the control circuit 120 causes the switching elements 110a, 110b to be turned OFF and disconnects the DERs 5 from the grid 3 in order to prevent the DERs 5 from supplying power to the grid 3 during the power outage. Upon turning OFF the switching elements 110a, 110b, the branch circuit breakers 400 supply power from the DERs 5 to the loads 7. The control circuit 120 can also detect the presence of the (restored) grid power based on the signal from the measurement circuit 130 that indicates the presence of the grid line voltage over a predetermined period (e.g., without limitation, 60 seconds). Upon detecting the presence of the grid power, the control circuit 120 causes the switching elements 110a, 110b to be turned ON and (re) connects the DERs 5 to the grid 3 and allows the DERs 5 to supply power to the grid 3. Upon turning ON of the switching elements 110a, 110b, the branch circuit breakers 400 supply power to the loads 7 from the grid 3 via the islanding switch 100. In another example, the control circuit 120 can detect an available DER 5 ready to supply power to the loads 7 based on a signal from the available DER 5 via the communication module 140. Upon detection of the available DER 5, the control circuit 120 causes the switching elements 110a, 110b to be turned OFF and disconnects the DERs 5 from the grid 3. This places the microgrid 1 in an intentional or scheduled islanded mode and allows the available DER 5 to supply power to the loads 5 in the islanded mode.

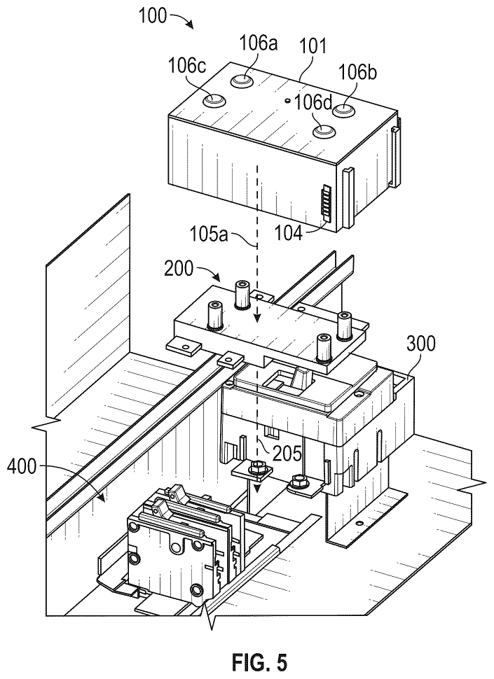

The coupling assembly 200 is structured to integrate the islanding switch 100 between the meter breaker 300 and the branch circuit breakers 400 in series. The islanding switch 100 is affixed to the coupling assembly 200 first as shown by the arrow 105a, and then to the load panel 10 as shown by the arrow 105b in FIG. 5. The coupling assembly 200 includes a base 201, fixing elements 204a,204b, four coupling busbars 224a-d and four sockets 212a-d. While FIGS. 2 and 4-6 show the coupling assembly 200 including four sockets and four coupling busbars, it will be understood that the numbers of the sockets and coupling busbars may vary depending on the circumstances and needs of the user. The base 201 may be attached to the bottom edge 108a of the sidewall 108. The base 201 may be an over molded polymer and structured to fixedly enclose portions of the sockets 212a-d and the coupling busbars 224a-d. The fixing elements 204a,204b may be, e.g., without limitation, screws or clinch bolts, and include upper fixing elements 204a structured to affix the islanding switch 100 to the coupling assembly 200 and lower fixing elements 204b structured to affix the islanding switch 100 to the meter or branch circuit breakers 300,400. The coupling busbars 224a-d include inner portions 221a-d embedded within the base 201 and outer portions 222a-d structured to be affixed to the meter breaker 300 and the branch circuit breakers 400. Each outer portion 222a-d may include a thru-hole 226a-d. Alternatively, each outer portion 222a-d may include a taped-hole or a clinch nut. The sockets 212a-d include lower ends 213a-d, upper ends 215a-d and bodies 214a-d extending therebetween. The lower ends 213a-d are affixed to inner portions 221a-d of respective coupling busbars 224a-d. The upper ends 215a-d are affixed to respective socket joints 102 of the islanding switch 100. The upper end 215a-d of a socket 212a-d may include an aperture and be structured to be affixed to the respective socket joint 102 of the islanding switch 100 by inserting an upper fixing element 204a into the body 214a-d via the aperture. The body 214a-d may include a cavity with internal threads to be engaged with an upper fixing element 204a. In addition, the sockets 212a-d of the coupling assembly 200 is symmetric with respect to the center line 208 running in parallel to the longitudinal axis of the load panels 10, but asymmetric with respect to the center line 209 running in parallel to the lateral axis of the load panels 10 in order to avoid the inverse connection of the islanding switch 100 to the coupling assembly 200. The sockets 212a-d may be threaded or press fit, depending on the type of the socket joints 102. While FIGS. 4-6 show the socket 212a-d having a cylindrical shape, this is for the illustrative purposes only, and thus the sockets may have any other shape appropriate to be attached to the socket joints 102 of the islanding switch 100. As such, the coupling assembly 200 fixedly attaches the upper ends 215a-d of the sockets 212a-d to the respective socket joints 102 by inserting the upper fixing elements 204a through the channels 103 and fastening the socket joints 102 to the upper ends 215a-d of the sockets 212a-d by the upper fixing elements 204a-d as shown by the arrows 207a,207b (as shown in FIG. 6). It is noted that FIG. 6 shows fastening only two socket joints 102 to two sockets 212a,212b by inserting the upper fixing elements 204a via two channels 103 for the illustrative clarity.

Next, the islanding switch 100 securely affixed to the coupling assembly 200 is integrated between the meter breaker 300 and branch circuit breakers 400. The integration of the islanding switch 100 is described busbar by busbar and socket by socket. The coupling busbars 224a-d include two line side coupling busbars 224a,224b and two load side coupling busbars 224c,224d. The sockets 212a-d include two line side sockets 212a,212b connected to the line side coupling busbars 224a,b and two load side sockets 212c,d connected to the load side coupling busbars 224c,d. As such, the inner portion 221a of the line side coupling busbar 224a is connected to the lower end 213a of the line side socket 212a, and the outer portion 222a of the line side coupling busbar 224a is connected to the output terminal 312a of the meter breaker 300, which in turn is connected to the line conductor L1 12a. The line side socket 212a is connected to the islanding switch 100 and structured to receive L1 input signal from the islanding switch 100. Thus, the line side socket 212a conducts the L1 current from the grid 3 during the grid-connected mode and no current during the power outage. The inner portion 221b of the line side coupling busbar 224b is connected to the lower end 213b of the line side socket 212b and the outer portion 222b of the line side coupling busbar 224b is connected to the output terminal 312b of the meter breaker 300, which in turn is connected to the line conductor L2 12b. The line side socket 212b is connected to the islanding switch 100 and structured to receive L2 input signal from the islanding switch 100. Thus, the line side socket 212b conducts the L2 current from the grid 3 during the grid-connected mode and no current during the power outage. The inner portion 221c of the load side coupling busbar 224c is connected to the lower end 213c of the load side socket 212c and the outer portion 222c of the load side coupling busbar 224c is connected to the branch busbar 424, which in turn is connected to input terminals (not shown) of branch circuit breakers 400. The load side socket 212c is connected to the islanding switch 100 and structured to receive an output signal from the islanding switch 100. The load side socket 212c conducts L1 current from the grid 3 during the grid-connected mode or alternative current from the DERs 5 during the power outage. The inner portion 221d of the load side coupling busbar 224d is connected to the lower portion 213d of the load side socket 212d and the outer portion 222d of the load side coupling busbar 224d is connected to the branch busbar 424. The load side socket 212d is connected to the branch busbar 424 and structured to receive an output signal from the islanding switch 100. Thus, the load side socket 212d conducts L1 current from the grid during the grid-connected mode or alternative current from the DERs 5 during the power outage.

Upon integration of the islanding switch 100 within the load panel 10 by the coupling assembly 200, the islanding switch 100 can perform the anti-islanding functionalities. During the grid-connected mode, the control circuit 120 causes the switching elements 110a, 110b to be turned ON and connects the DERs 5 to the grid 3 and allows the DERs 5 to supply power to the grid 3. Further, upon turning ON the switching elements 110a, 110b, the line side sockets 212a,212b conduct the line currents from the grid 3 and the load side sockets 212c,212d output the line currents to the branch circuit breakers 400, which in turn supply power to the loads 7 from the grid 3. Upon detection of a power outage, the control circuit 120 causes the switching elements 110a, 110b to be turned OFF and disconnects the DERs 5 from the grid 3 and prevents the DERs 5 from supplying power to the grid 3. Upon turning OFF the switching elements 110a, 110b, the line side sockets 212a,212b are disconnected and the load side sockets 212c,212d receive power from the DERs 5 and the branch circuit breakers 400 then supply power to the loads from the DERs 5.

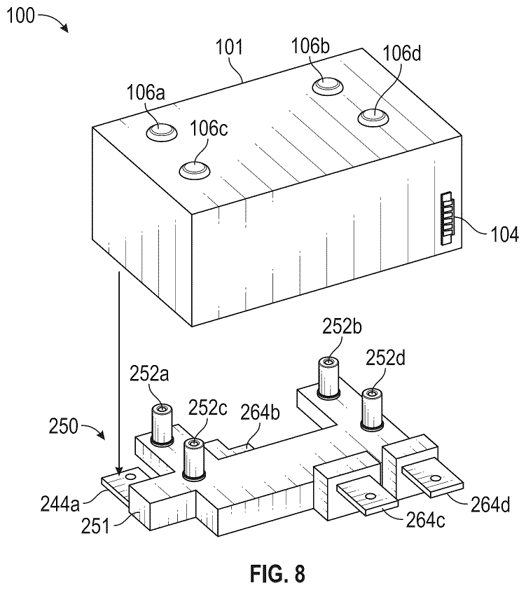

FIG. 8 illustrates another exemplary coupling assembly 250 structured to fixedly attach the islanding switch 200 to the meter and branch circuit breakers 300,400 in accordance with a non-limiting, exemplary embodiment of the disclosed concept. The coupling assembly 250 is similar to the coupling assembly 200 of FIGS. 4-6 except in that the shape and arrangement of the base 251 and the coupling busbars 264a-d arc different from those of the based 201 and the coupling busbars 224a-d of the coupling assembly 200 in order to accommodate various dimensions, configurations, structures of any type of the meter breakers. However, the sockets 252a-d have the same positions and arrangements relative to the islanding switch 100 as those of the sockets 212a-d of the coupling assembly 200 in order to allow a uniform fitment design between the sockets and the islanding switches for any type of load centers or meter breakers. Accordingly, a poke-yoke condition (the inverse connection) of the islanding switch 100 to the coupling assembly 200,250 is avoided.

Accordingly, the exemplary embodiments of the disclosed concept provide the coupling assembly 200,250 for customized fitment of the compact islanding switch 100 for any types of meter breakers and/or load centers with no or minimal modifications to the existing panels and breakers and without compromising the performance of the islanding switches. Further, the novel customizable coupling assemblies 200,250 allow safe, simple and fast installation of the compact islanding switches 100 within the existing load panels 10. For example, the conventional islanding switches 150 may require more than several hours to be installed whereas the novel compact islanding switches 100 can be installed within minutes using the coupling assemblies 200,250. Furthermore, integrating the compact islanding switch 100 internally using the coupling assembly 200,250 customized for the existing panels and circuit breakers prevents or minimizes waste or loss of branch circuit breakers and significantly reduces cost, time and resources expended in implementing the required anti-islanding mechanism. Additionally, the coupling assemblies can have different designs to accommodate various types, structures, configurations and/or spacing availability within the panels and between the breakers, while maintaining the symmetry of the sockets and islanding switch signals in the line side and load side, thereby preventing the poke-yoke condition.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. An islanding switch for use in a load panel included in an energy distribution system comprising one or more distributed energy resources (DERs), a utility grid and loads, the load panel including a meter breaker connected to the utility grid and branch circuit breakers connected to the loads, the islanding switch comprising:
a frame including a top having multiple openings, a sidewall extending vertically downward from the top, multiple channels extending vertically between the peripheries of the openings to bottom edge of the sidewall, and multiple socket joints extending horizontally across the channels above the bottom edge;
islanding circuits disposed within the frame and including switching elements, a measurement circuit structured to measure line voltage, and a control circuit structured to detect a power outage or gird power based on the measured line voltage and cause the switching elements to disconnect the DERs from the utility grid upon detecting the power outage; and
a coupling assembly including a base, multiple coupling busbars including inner portions embedded within the base and outer portions structured to be affixed to the meter breaker and the branch circuit breakers, multiple sockets having lower ends affixed to inner portions of respective coupling busbars and upper ends affixed to respective socket joints.

2. The islanding switch of claim 1, wherein the coupling assembly further comprises upper fixing elements and lower fixing elements, and wherein the coupling assembly fixedly attaches the upper ends of the sockets to the respective socket joints by inserting the upper fixing elements through the channels and fastening the socket joints to the upper ends of the sockets by the upper fixing elements.

3. The islanding switch of claim 2, wherein the multiple coupling busbars include two line side coupling busbars and two load side coupling busbars, and wherein the multiple sockets include two line side sockets connected to the line side coupling busbars and two load side sockets connected to the load side coupling busbars, and wherein the meter breaker includes line conductors connected to the utility grid and output terminals connected to the line conductors, and wherein the branch circuit breakers are connected to a branch busbar.

4. The islanding switch of claim 3, wherein the coupling assembly fixedly attaches the islanding switch to the meter breaker by fastening the outer portions of the line side coupling busbars to the output terminals of the meter breaker via the lower fixing elements, and wherein the coupling assembly fixedly attaches the islanding switch to the branch circuit breakers by fastening the outer portions of the load side coupling busbars to the branch busbar via the lower fixing elements.

5. The islanding switch of claim 4, wherein during a power outage, the line side sockets do not conduct and the load side sockets output power from the DERs to the branch circuit breakers based on a control signal from the control circuit, and wherein the branch circuit breakers provide power from the DERs to the loads.

6. The islanding switch of claim 4, wherein upon detecting the grid power, the line side sockets conduct line current from the utility grid and the load side sockets output the grid power to the branch circuit breakers based on a control signal from the control circuit, and wherein the branch circuit breakers provide power from the utility grid to the loads.

7. The islanding switch of claim 1, wherein the base of the coupling assembly is an over molded polymer and structured to fixedly secure the sockets and the coupling busbars in respective predetermined positions.

8. The islanding switch of claim 1, wherein the sockets are symmetric relative to a center line running in parallel to the longitudinal axis of the load panel, but are asymmetric relative to a center line running in parallel to the lateral axis of the load panel such that an inverse connection of the islanding switch to the coupling assembly is prevented.

9. The islanding switch of claim 1, wherein the lower ends of the sockets are connected to socket connecting parts of the inner portions of at socket connecting parts, and wherein the arrangement of the sockets and the socket connecting parts of the coupling busbars is to remain unchanged for a uniform fitment of the islanding switch in various types of meter breakers or load centers.

10. The islanding switch of claim 9, wherein the arrangement of the outer portions of the coupling busbars and the inner portions exclusive of the socket connecting parts is variable based on configurations of the meter breakers.

11. The islanding switch of claim 1, further comprising a communication port communicatively coupled to components of the energy redistribution system and structured to receive signals from the components, the signals including a availability of a DER read to supply power to the utility grid or the loads.

12. A load panel for use in an energy distribution system including one or more distributed energy resources (DERs), a utility grid and loads, the load panel comprising:
a housing;
a meter breaker disposed within the housing and including line conductors connected to the utility;
a plurality of branch circuit breakers disposed within the housing and connected to the loads; and
an islanding switch including a coupling assembly connecting the meter breaker and the branch circuit breakers, wherein the islanding switch is structured to disconnect the DERs from the utility grid and prevent the DERs from supplying power to the utility grid during a power outage and connect the DERs to the utility grid and allow the DERs to supply power to the utility grid during a grid-connected mode.

13. The load panel of claim 12, wherein the islanding switch further includes:
a frame including a top having multiple openings, a sidewall extending vertically downward from the top, multiple channels extending vertically between the peripheries of the openings to bottom edge of the sidewall, and multiple socket joints extending horizontally across the channels above the bottom edge; and
islanding circuits disposed within the frame and including switching elements, a measurement circuit structured to measure line voltage, and a control circuit structured to detect grid power based on the measured line voltage and cause the switching elements to disconnect the DERs from the utility grid upon detecting a power outage and connect the DERs to the utility grid upon detecting the grid power.

14. The load panel of claim 13, wherein the coupling assembly comprises:
a base;
multiple coupling busbars including inner portions embedded within the base and outer portions structured to be affixed to the meter breaker and the branch circuit breakers;
multiple sockets having lower ends affixed to inner portions of respective coupling busbars and upper ends affixed to respective socket joints; and
upper fixing elements and lower fixing elements, and wherein the coupling assembly fixedly attaches the upper ends of the sockets to the respective socket joints by inserting the upper fixing elements through the channels and fastening the socket joints to the sockets by the upper fixing elements.

15. The load panel of claim 14, wherein the multiple coupling busbars include two line side coupling busbars and two load side coupling busbars and the multiple sockets include two line side sockets connected to the line side coupling busbars and two load side sockets connected to the load side coupling busbars, and wherein the meter breaker includes line conductors connected to the utility grid and output terminals connected to the line conductors, and wherein the branch circuit breakers are connected to a branch busbar.

16. The energy distribution system of claim 15, wherein the coupling assembly fixedly attaches the islanding switch to the meter breaker by fastening the outer portions of the line side coupling busbars to the output terminals of the meter breaker via the lower fixing elements, and wherein the coupling assembly fixedly attaches the islanding switch to the branch circuit breakers by fastening the outer portions of the load side coupling busbars to the branch busbar via the lower fixing elements.

17. An energy distribution system comprising:
a plurality of loads;
a utility grid structured to provide power to the loads during a grid-connected mode;
one or more distributed energy resources (DERs) structured to supply power to the utility grid during the grid-connected mode and provide power to the loads during an islanded mode; and
a load panel including a housing, a meter breaker disposed within the housing and including line conductors connected to the utility, a plurality of branch circuit breakers disposed within the housing and connected to the loads; and an islanding switch including a coupling assembly connecting the meter breaker and the branch circuit breakers, wherein the islanding switch is structured to disconnect the DERs from the utility grid and prevent the DERs from supplying power to the utility grid during a power outage and connect the DERs to the utility grid and allow the DERs to supply power to the utility grid during a grid-connected mode.

18. The energy distribution system of claim 17, wherein the islanding switch further includes:
a frame including a top having multiple openings, a sidewall extending vertically downward from the top, multiple channels extending vertically between the peripheries of the openings to bottom edge of the sidewall, and multiple socket joints extending horizontally across the channels above the bottom edge; and
islanding circuits disposed within the frame and including switching elements, a measurement circuit structured to measure line voltage, and a control circuit structured to detect grid power based on the measured line voltage and cause the switching elements to disconnect the DERs from the utility grid upon detecting a power outage and connect the DERs to the utility grid upon detecting the grid power.

19. The energy distribution system of claim 18, wherein the coupling assembly comprises:
a base;
multiple coupling busbars including inner portions embedded within the base and outer portions structured to be affixed to the meter breaker and the branch circuit breakers, the coupling busbars including two line side coupling busbars and two load side coupling busbars;
multiple sockets having lower ends affixed to inner portions of respective coupling busbars and upper ends affixed to respective socket joints, the sockets including two line side sockets connected to the line side coupling busbars and two load side sockets connected to the load side coupling busbars; and
upper fixing elements and lower fixing elements, and wherein the coupling assembly fixedly attaches the upper ends of the sockets to the respective socket joints by inserting the upper fixing elements through the channels and fastening the socket joints to the sockets by the upper fixing elements.

20. The energy distribution system of claim 19, wherein the meter breaker includes line conductors connected to the utility grid and output terminals connected to the line conductors and the branch circuit breakers are connected to a branch busbar, and wherein the coupling assembly fixedly attaches the islanding switch to the meter breaker by fastening the outer portions of the line side coupling busbars to the output terminals of the meter breaker via the lower fixing elements, and wherein the coupling assembly fixedly attaches the islanding switch to the branch circuit breakers by fastening the outer portions of the load side coupling busbars to the branch busbar via the lower fixing elements.
